(19) United States
(12) Patent Application Publication
(10) Pub. No.: US 2023/0166821 A1
(43) Pub. Date: Jun. 1, 2023

(54) COMPACT, LIGHTWEIGHT HYDRAULIC MANIPULATION SYSTEM FOR UNDERWATER APPLICATIONS

(71) Applicant: VERSITECH LIMITED, Hong Kong (HK)

(72) Inventors: Zheng Wang, Hong Kong (HK); Zhong Shen, Hong Kong (HK); Yafiei Zhao, Hong Kong (HK); Hua Zhong, Hong Kong (HK)

(21) Appl. No.: 17/920,814

(22) PCT Filed: Mar. 22, 2021
(86) PCT No.: PCT/CN2021/082049

§ 371 Date: Oct. 24, 2022

Related U.S. Application Data
(60) Provisional application No. 63/017,681, filed on Apr. 30, 2020.

(51) Int. Cl. B63G 8/00; B25J 15/08; B25J 9/14; B63C 11/52; B25J 15/00

(52) U.S. Cl. CPC B63G 8/001; B25J 15/08; B25J 9/142; B63C 11/52; B25J 15/0023

(57) ABSTRACT

Disclosed is a compact, lightweight hydraulic manipulation system used for underwater applications consisting of two parts: a modulus hybrid underwater manipulator and a compact lightweight hydraulic control framework. The system is used for general underwater work such as underwater sampling, hyperbaric welding, and marine aquaculture.

### TECHNICAL FIELD

Disclosed are compact, lightweight hydraulic manipulation devices, systems, and methods used for underwater applications. The devices, systems, and methods are used for underwater sampling, hyperbaric welding, and marine aquaculture, among other underwater uses.

### BACKGROUND

Underwater sampling is essential for the scientific study of marine life. Conventionally, at least four experienced divers are needed for underwater sampling in the shallow depth water within the photonic zone especially in tropical waters with prominently vibrant biodiversity. Considering the high risk and physical limitations for divers in the highly dynamic underwater environment, remotely operated vehicles (ROVs) and autonomous underwater vehicles are actively developed and widely used for underwater exploration and intervention. However, underwater manipulation, with primary focuses in underwater intervention with physical interactions, remains highly challenging, with most commercially available underwater manipulators with either primitive dexterity (1-2 DOFs) or heavy/bulky toward heavy duty applications. The rigidity of conventional rigid body manipulators also makes it very difficult for handling soft and fragile aquatic specimens. Also, high pressure hydraulic actuation and control systems, often heavier and bulkier than the manipulators themselves, are generally required to drive such systems under the water pressure at the working depth. In this case, a substantially large under-water platform is required to provide underwater mobility for such manipulators and the corresponding actuation systems. The escalated size, weight, cost, and serviceability are significantly restricting their wider applications.

Soft robotic offers a new approach to underwater manipulation compared with conventional rigid-bodied robots. In particular, the inherent adaptation and waterproofing of soft actuators are ideal for grabbing delicate and flexible objects underwater, inherited from cable-driven and biomimetic approaches. Fluidic elastomer actuators also work well in underwater applications, in terms of continuum structures, hybrid structures, and even modular structures, tested in a high pressure environment equivalent to 2300 m depth. Three-dimensional printed soft robotic manipulators have also been proven highly successful in deep-sea operations, tested for more than 2200 m depth, offering much better compactness and inherent compliance than rigid manipulators for delicate underwater sampling.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

An underwater manipulator is essential for underwater robotic sampling and other service operations. Conventional rigid body underwater manipulators generally required substantial size and weight, leading to hindered general applications. Pioneering soft robotic underwater manipulators have defied this by offering dexterous and lightweight arms and grippers, but still requiring substantial actuation and control components to withstand the water pressure and achieving the desired dynamic performance. In this work, we propose a novel approach to underwater manipulator design and control, exploiting the unique characteristics of soft robots, with a hybrid structure (rigid frame+soft actuator) for improved rigidity and force output, a uniform actuator design allowing one compact hydraulic actuation system to drive all actuators, and a novel fully customizable soft bladder design that improves performances in multiple areas: (1) force output of the actuator is decoupled from the working depth, enabling wide working ranges; (2) all actuators are connected to the main hydraulic line without actuator-specific control loop, resulting in a very compact actuation system especially for high-dexterity cases; (3) dynamic responses were improved significantly compared with the counter system without bladder. A prototype soft manipulator with 4-DOFs, dual bladders, and 15 N payload was developed; the entire system (including actuation, control, and batteries) could be mounted onto a consumer-grade remotely operated vehicle, with depth-independent performances validated by various laboratory and field test results across various climatic and hydrographic conditions. Analytical models and validations of the proposed soft bladder design were also presented as a guideline for other applications.

Disclosed herein are devices for underwater applications, made of a hybrid underwater manipulator; and a hydraulic control framework comprising at least two compensating soft bladders.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF SUMMARY OF THE DRAWINGS

FIG. 1 depicts an underwater manipulator with soft bladder-based hydraulic system mounted on a consumer-grade ROV (remotely operated vehicle) in accordance with an embodiment.

FIG. 2 depicts a comparison between the conventional underwater manipulation system and the CSB-based manipulation system in accordance with an embodiment. FIG. 2a is a conventional underwater manipulation system. The whole system is isolated from ambient water so that an oil tank is needed as a liquid source. At least one high power hydraulic pump is required to counter ambient water pressure. High power actuation units are also needed for fast response, and each actuator requires an individual feedback loop for dexterous and accurate control. FIG. 2b depicts an underwater manipulation system in accordance with an embodiment. Only electronic components are sealed. A liquid source directly comes from ambient water, and both CSBs and actuators are exposed to ambient water, ensuring that the ambient water pressure is balanced. All the actuators are controlled by the inlet and outlet control loops compactness and simplicity. The improved dynamic response can be achieved by using the elasticity of the two CSBs (compensating soft bladder).

FIG. 3 depicts a system overview in accordance with an embodiment. FIG. 3a is a schematic drawing of the proposed underwater hydraulic system. FIG. 3b depicts the underwater hydraulic system with the manipulator.

FIG. 4 depicts the manipulator characterization in accordance with an embodiment. On the left, a schematic drawing of the manipulator's motion, in the middle, an exposed view of the manipulator, and on the right, a dexterous hybrid underwater manipulator.

FIG. 5a depicts the CSB molding process (inlet). The outlet CSB molding process is the same except there is no fiber reinforcement. FIG. 5b depicts the soft actuator molding process. Gripper and wrist actuators follow the same procedure but different lengths. FIG. 5c is a schematic drawing of the two CSBs. The upper one is the inlet CSB (elongation), and the lower one is the outlet CSB (contraction) λe and λc are principle stretch ratios for the inlet and outlet CSBs, respectively. FIG. 5d graphically illustrates the CSB pressure versus strain test results (inlet: upper, outlet: lower). Blue lines are analytical results, and red dots are experimental results. FIG. 5e graphically illustrates the CSB flow speed versus pressure difference test results (inlet: upper, outlet: lower). ANA, analytical; EXP, experimental.

FIG. 6 CSB testing platform setup in accordance with an embodiment.

FIG. 7 and Table 1 depict a CSB-based hydraulic system tracking performance test results in accordance with an embodiment. FIG. 7a shows the P-a (step function) tracking performance. FIG. 7b shows the P-b (sinusoidal signal) tracking performance. FIGS. 7c-7f show the P-c (increased frequency with sinusoidal signal) tracking performance for all four system setups. The red shadow is the tracking time before tracking failure (critical time).

FIG. 8 depicts the soft actuator and gripping force test. FIG. 8a and FIG. 8b report soft actuator stress versus strain test results (wrist and gripper actuators). FIG. 8c and FIG. 8d report soft actuator force versus pressure test results (wrist and gripper actuators). FIG. 8e reports hybrid gripper gripping force test results (with different inlet CSB pressures). FIG. 8f depicts a soft actuator validation test setup (upper: gripper actuator; lower: wrist actuator). FIG. 8g shows the gripper test setup. The force sensor was mounted to one finger of the gripper; no further restrictions were added, except for mounting the force sensor to the one finger, the rest of the gripper was in its natural working state.

FIG. 9 reports the manipulation system test under different water depths. FIG. 9a reports the testing results. The test was carried out onshore, in a water tank, and in the sea. FIG. 9b shows the clay box used to demonstrate gripping force. The bottom listed clay boxes with all tested depths.

FIG. 10 depicts hybrid manipulator system validation. FIG. 10a depicts a fifteen-meter water tunnel for speed test. FIG. 10b depicts a manipulator dexterity and accuracy test (pick and place) setup (onshore). FIG. 10c depicts a pick and place procedure. FIG. 10d depicts a comparison between a single ROV and the same ROV with the underwater manipulation system in the speed test.

FIG. 11 shows the underwater manipulation system validation studies in 3 hot spots of marine biodiversity with different hydrographic and climatic conditions. FIG. 11a Maldives, Kandima Island coral lagoon; FIG. 11b Taiwan, Guishan Island; and FIG. 11c Hong Kong, west coast.

### DETAILED DESCRIPTION

The state-of-the-art solutions remain compromised between compactness, lightweight, and dexterity, mainly due to the hydraulic actuation and control components for existing soft manipulators are still similar with those of rigid manipulators: (1) for dexterity, multiple actuators require dedicated pressure-regulation feedback loops; (2) for working depth, matching actuation pressure is required to counter the ambient water pressure at the working depth; (3) for fast response time, a high power actuation unit is often needed. Some efforts have been made to address the limitations, from a compact pneumatic system with chemical reactions (not applicable for underwater application) to jamming grippers with ambient water pressure compensation for object picking with primitive dexterity. In particular, an accumulator was made to both counter ambient pressure and increase the flow rate in the actuation level. A spring was used in the accumulator to hold ambient pressure and provide an increased flow rate. Therefore, to achieve compact, lightweight, and fast response simultaneously, innovations are required in the actuation and control systems on the developing stage.

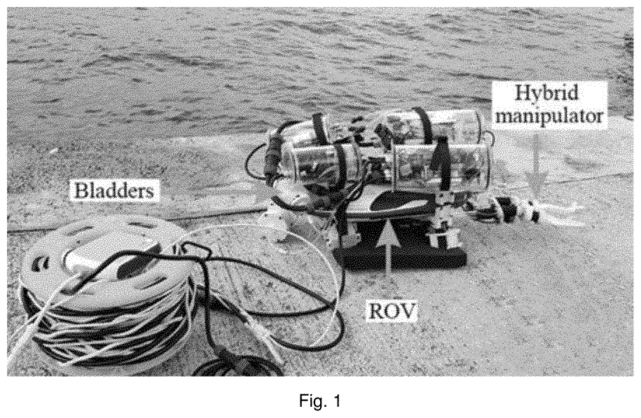

As described herein, a novel hybrid underwater manipulator framework is provided, characterized, and demonstrated, with uniform soft actuator design and soft bladder hydraulic actuation (FIG. 1), achieving dexterity, compactness, depth independence, and fast response, by using two compensating soft bladders (CSBs) in the hydraulic actuation system. Complete works on the mechanical design, analytical modeling of the CSB and soft actuators, as well as prototyping work are presented, together with various test results in controlled- and open-water environments in different field sites in the tropical areas with various hydrographic conditions.

The main contributions are the multipurpose CSB concept and the overall soft manipulator actuation and control approach based on it, achieving a unique combination of experimentally verified characteristics distinguishing from the state-of-the-art solutions: (1) high compactness, with CSBs, the entire prototype arm with 15 N payload and 4-DOF dexterity, weighed 2.5 kg (including battery and electronics), and can be mounted onto a recreational ROV platform; (2) depth independence, uniform force output performance across the entire working depth range, irrelevant of ambient water pressure changes; (3) improved dynamic response, nearly twice faster response by using CSBs in the hydraulic loop.

Results on the manipulator as described herein are highly promising for a dexterous, compact, and lightweight soft robotic manipulator with nearly uniform payload and dynamic performances across the entire designated working depth range. Following this approach, recreational-grade ROVs can be equipped with easy-to-carry and easy-to-use soft arms, leading to mass applications in both diver assistance and underwater operations.

### Conceptual Design and System Overview

### Design Requirements

The targeted design of a soft robotic manipulator for general underwater sampling and manipulation tasks is desirable to be compact, easy-to-operate, with large working depth range, while also being responsive and task-capable.

These rather contradicting features are depicted in the following design requirements:

(1) Compactness. The complete self-containing underwater system supporting the manipulator should be able to fit a consumer-grade compact ROV, significantly more compact than existing underwater manipulators. Therefore, conventional hydraulic tanks can be eliminated, and compact pumps/valves are preferred over conventional compressors/cylinders, with minimalistic actuation and control hardware.

(2) Large working depth range. With the limited pressure range from the compact hydraulic components being used, ambient water pressure becomes a vital factor to the hydraulic performance. Measures can be implemented to ensure the operation and performance of the soft manipulator being independent of the working depth.

(3) Fast response. Fast response and tracking capability are critical for the dynamic tasks of sampling and manipulation. Considering the limited flow rate and response time for the compact actuation components, measures can be implemented to improve the dynamic response.

(4) Soft arms. Considering the complex underwater environmental factors and the inherent compliant features for soft robots, an easy-to-carry and easy-to-use soft arm is needed for underwater sampling tasks.

### Underwater Manipulation System Overview

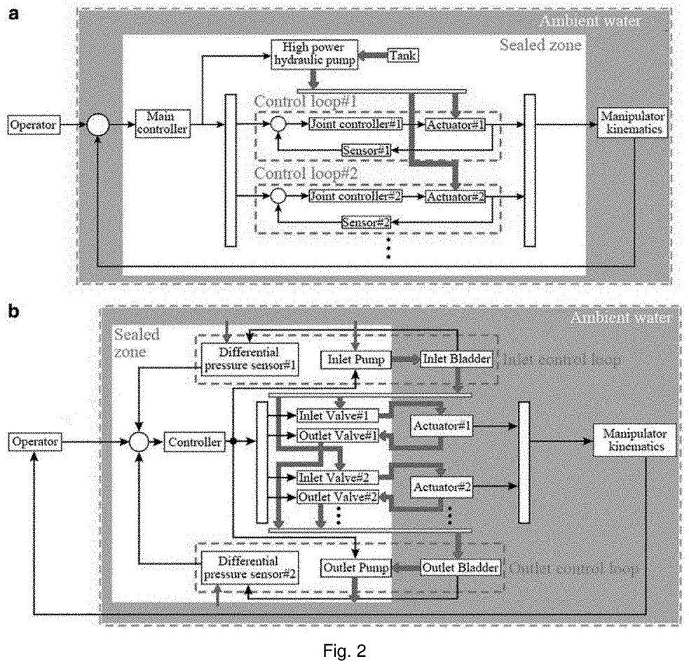

The proposed underwater manipulation system was largely modified compared with conventional hydraulic underwater manipulators (FIG. 2) to meet the design requirements. The key features are as follows:

(1) A CSB-based control strategy is used to minimize the use of pumps, valves, and control hardware. Compared with conventional underwater manipulators that use individual control loops for each actuator, the hydraulic system described herein only has two control loops for all the actuators used in the manipulator. As the two CSBs are linked to all the actuators, they act like pressure control units. Also, the CSBs can protect actuators from exceeding the maximum pressure threshold by presetting the working pressure ranges.

(2) The two CSBs are exposed to ambient water to balance ambient water pressure. In this case, the pumps' working pressure is independent of ambient water depth. Compared with the accumulator used by Phillips et al., (Phillips B T, Becker K P, Kurumaya S, et al. A dexterous, glove-based teleoperable low-power soft robotic arm for delicate deep-sea biological exploration. Sci Rep 2018; 8:14779) which used a spring to hold ambient pressure, the two CSBs naturally counter ambient pressure, taking advantage of the inherent compliance of soft robots. In this case, the water depth factor can be removed in the developing level.

(3) The inherent flexibility of the two CSBs is used to achieve fast dynamic responses and tracking capability. By setting a working pressure range for the CSBs, pressure differences will be generated between the CSBs and the actuators. In this case, water comes from the pumps can be released with a much larger flow rate. Also, by tuning materials and wall thickness using the analytical model proposed in the Design and Modeling of CSBs and Actuators section, the CSBs can be customized for different applications.

(4) Modularized actuator design is carried out in the underwater manipulation system. As soft actuators' pressure can be controlled by two CSBs and corresponding valves, sensors are not necessary for each actuator. In this case, only valves and actuators need to be added into the system when calling for more degrees of freedom (DOFs). Also, the modular design helps keep the compactness of the system when DOFs are added.

### The Proposed CSB-Based Hydraulic Control Framework

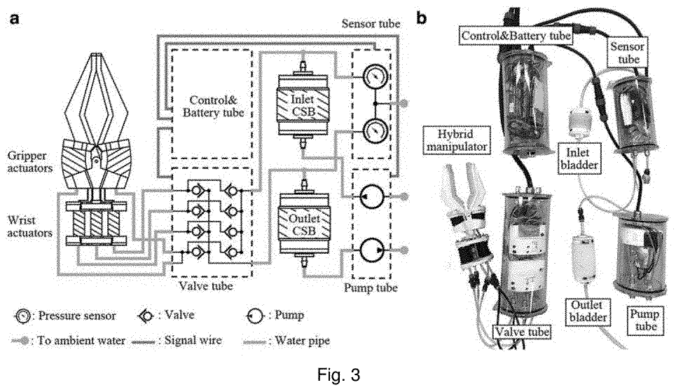

The proposed hydraulic control framework shown in FIG. 3 serves multiple purposes including system compactness, wide working depth range, and dynamic performance. The hydraulic system consists of eight valves (2.5 W each), two pumps (7.2 W each), two CSBs, two pressure sensors, and one control unit. The maximum power consumption is 34.4 W, which is less than half of the power required for standard underwater manipulators. For the sake of waterproofing and compactness, all the electronic components are put into four acrylic tubes. The four tubes are 100 mm in diameter, and the length ranged from 140 to 250 mm. Overall the whole system, weighted 2.5 kg, can be fit into a 400×500×250 mm box. The weight in water is about zero. The two pumps are connected with two CSBs separately, and ambient water pressure is balanced as the CSBs are exposed to ambient water. Three actuators on the joint correspond to six valves, the rest two valves are connected with the two actuators on the gripper as these two actuators move simultaneously. All the actuators are controlled by two CSBs and the corresponding valves. The system's dynamic performance is improved by presetting two CSBs to pre-established pressure ranges, as the large pressure differences created between actuators and two CSBs will result in a higher flow rate. In this embodiment, the maximum pressure for the CSBs is set to 15 psi due to 3D printed parts limitation.

When the hydraulic system is activated, the two CSBs are pumped to the preset pressure ranges (inlet positive and outlet negative) first. The pressure ranges are determined so that all the actuators can perform within safe working pressure ranges and the response time can be largely reduced. As the two CSBs are exposed to water, they also act like water depth pressure compensators. So whatever the depth is, the two pumps only need to provide pressure difference. When a command signal is received and an actuator needs to be elongated or contracted, the corresponding valves are opened by the control unit and water is released from (inlet)/to (outlet) the two CSBs first. When the pressure in the two CSBs exceeds the preset ranges, the two pumps are activated again to keep the pressure ranges within the preset value.

### Design of the Hybrid Manipulator

A hybrid design is carried out for the underwater manipulator. On the one hand, giving complex underwater environments, soft robotics has the advantage of inherent compliance compared with conventional rigid-bodied robots. On the other hand, better accuracy and larger payload can be achieved by applying rigid parts in the design.

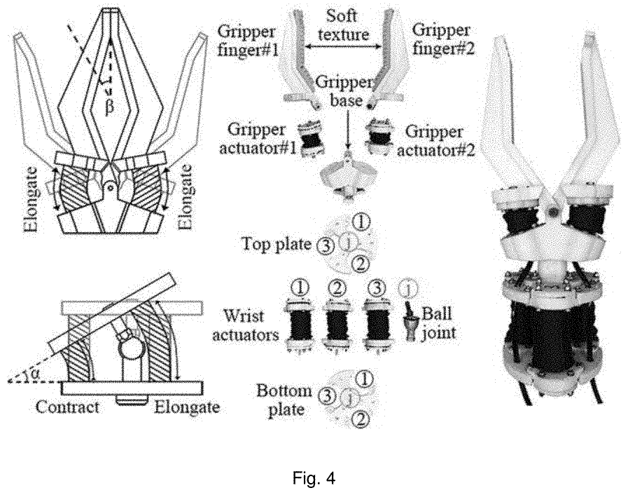

The underwater manipulator (FIG. 4) consists of two parts: the gripper and the wrist. The gripper has two fingers, both of which are covered with soft textures to increase friction. The two fingers are mounted on the gripper base and two gripper actuators are fixed in between the fingers and the base. The gripper closes when these two actuators are elongated, as these two actuators move simultaneously. The maximum opening angle b is 85°. The wrist consists of three wrist actuators, a ball joint, and two 3D printed plates. The top and bottom plates are connected by the ball joint, and three soft actuators are placed triangularly along the edge of the plates. When one actuator is elongated, the other two are contracted accordingly, which results in the bending motion along with contracted actuators. The maximum bending angle a is 36°.

### Design and Modeling of CSBs and Actuators

Another component in the hydraulic system, the two CSBs play an unequaled role in the whole system's performance. In this case, the development of the two CSBs is separated from the hydraulic system to elaborate their functionalities in a more detailed manner. The soft actuators, however, share the same importance and similar fabrication process compared with CSBs. In this case, the actuators' development is put together with the CSBs for better understanding.

### Design and Fabrication of CSBs and Actuators

The CSBs proposed in this embodiment serve the purpose of reducing system bulkiness and complexity while optimizing the pump's output so that control response time can be largely reduced. To fulfill these goals, at least one of three requirements is satisfied: (1) Ambient water depth pressure can be passively balanced so that the water depth factor can be removed from the developing stage. (2) The pressure differences between the CSBs and the actuators are large enough to achieve fast response but not too large to cause damage to the actuators. (3) When pressure is increased, the CSBs need to have enough volume change for the actuators. Taking advantage of the inherent compliance and water-proofing of soft robot, and by exposing the two CSBs in water, ambient pressure no longer needs to be considered on the developing stage. To further investigate the relationship between the performance and the parameters of the CSBs, an analytical model was built up in the Design and Modeling of CSBs and Actuators section. And for the sake of easy investigation, the two CSBs were designed to deform in one axis only (elongation and contraction).

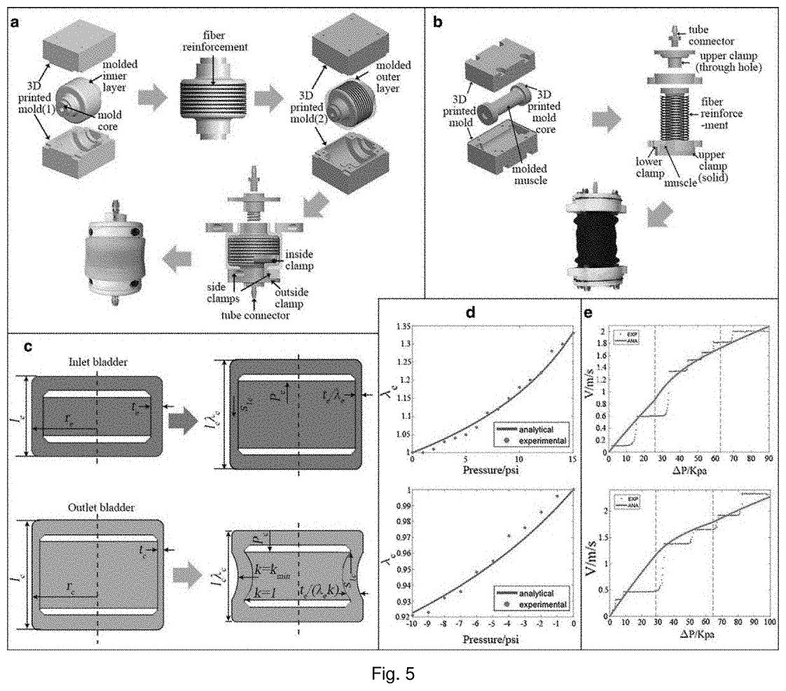

There are two CSBs used in the hydraulic system, one in the inlet (elongation) and the other in the outlet (contraction). Both of them share the same shape, but the elongation one has a fiber reinforcement layer, whereas the contraction one is pure silicone. The molding process for the inlet CSB is shown in FIG. 5a. The inner layer was first molded (dragon skin 30; Smooth-On, Inc.). After putting on the fiber reinforcement, the outer layer was molded (dragon skin 30; Smooth-On, Inc.). When it was cured, the 3D printed mold core was removed and clamps were added. For the outlet CSB, as there was no fiber reinforcement, it was only molded once (dragon skin 30; Smooth-On, Inc.).

All the five soft actuators used in the gripper and the wrist share the same structure but different length to meet with different requirements, for the purpose of reducing system complexity and realizing modularized actuator design. In particular, the two actuators used in the gripper are shorter to achieve a larger opening angle, whereas the three actuators used in the wrist are longer for larger bending angle. The molding process is as follows (FIG. 5b): The soft chamber was first molded (dragon skin 10; Smooth-On, Inc.) using 3D printed molds. Once the silicone was cured, a fiber reinforcement layer was added to restrict radial expanding. Both of the two sides of the soft chamber were then sealed using 3D printed clamps. Combining the hybrid manipulator design, one can modify the length and inner chamber radius of the actuator based on the demand, without redesigning the whole structure of the soft actuator.

### Analytical Modeling of CSBs

To simplify the analytical model, all the materials used in the CSB are considered incompressible, and the NeoHookean hyperelastic material model is used. The strain energy density function is given by

$$W = \frac{μ}{2} ( {I}_{1} - 3 ) , \qquad ( 1 )$$

where μ is the initial hear modulus, and I₁ is the first invariant of the three principle stretch ratios λ₁, λ₂, and λ₃:

I₁=λ₁²+λ₂²+λ₃². (2)
The principal stress is given by

$${s}_{i} = \frac{\partial W}{\partial {λ}_{i}} - \frac{p}{{λ}_{i}} , \qquad ( 3 )$$

where ρ it the Lagrange multiplier. For incompressible materials, we have λ₁λ₂λ₃=1. For the inlet CSB (FIG. 5c, upper one), as there is one fiber reinforcement layer, the circumferential strain is considered negligible, which gives λ₂ₑ=1. It is then obtained by

$${λ}_{1 e} = {λ}_{e} ; {λ}_{2 e} = 1 ; {λ}_{3 e} = \frac{1}{{λ}_{e}} . \qquad ( 4 )$$

For the outlet CSB shown in Figure Sc, as there are two circular 3D printed parts at the two ends, the circumferential strain at those two points is zero, which gives λ₂ₑ=1. While the principal stretch in the circumferential direction at the center of the CSB is k (k is a constant and 0>k≤1). It can be obtained by

$${λ}_{1 c} = {λ}_{c} ; {λ}_{2 c} = k ; {λ}_{3 c} = \frac{1}{k {λ}_{c}} . \qquad ( 5 )$$

For the sake of simplicity, although the inlet CSB consists of different materials with different initial shear modulus, they are considered as a homogeneous material with effective initial shear modulus β. For the inlet CSB, radial stress is considered balanced through the thickness (i.e., s₃=0). Considering a similar derivation procedure in the study by Polygerinos et al.,³⁵ Equation (3) is further simplified to

$${s}_{1 e} = \overline{μ} ( {λ}_{e} - \frac{1}{{λ}_{e}^{3}} ) . \qquad ( 6 )$$

For the outlet CSB, substituting Equations (1), (2) and (5) into Equation (3) yields

$${s}_{1 c} = \overline{μ} {λ}_{c} - \frac{p}{{λ}_{c}} \qquad ( 7 )$$

$${s}_{2 c} = \overline{μ} k - \frac{p}{k} \qquad ( 8 )$$

$${s}_{3 c} = \frac{\overline{μ}}{k {λ}_{c}} - k {λ}_{c} p . \qquad ( 9 )$$

For the inlet CSB, the balance is reached at the ends, which gives

PₑAₑ₁=s₁ₑAₑ₂, (10)
where Pₑ is the pressure difference inside and outside the CSB, Aₑ₁ is the CSBs cross-sectional area, and Aₑ₂ is the cross-sectional area of the silicone. Assuming the CSB has initial length lₑ, radius rₑ, and wall thickness tₑ, substituting Equation (3) into Equation (10) yields

$${P}_{e} {r}_{e}^{2} = \overline{μ} ( {λ}_{e} - \frac{1}{{λ}_{e}^{3}} ) ( {r}_{e}^{2} - {( {r}_{e} - \frac{{t}_{e}}{{λ}_{e}} )}^{2} ) . \qquad ( 11 )$$

For outlet CSB, when k=1, the force generated by pressure difference P_{c} is equal to the force generated by axial stress. When k=kₘᵢₙ, radial stress is balanced by the pressure difference P_{c}. It is then obtained by

P_{c}A_{c1}=s_{1c}A_{c2} (12)

P_{c}=s_{3c}, (13)
The initial condition of the CSB is given as l_{c}, r_{c}, and t_{c} for length, radius, and wall thickness, respectively. Combining Equations (7) and (9) into Equations (12) and (13) gives

$$π {P}_{c} {r}_{c}^{2} = π ( \overline{μ} {λ}_{c} - \frac{p}{{λ}_{c}} ) ( {r}_{c}^{2} - {( {r}_{c} - \frac{{t}_{c}}{{λ}_{c}} )}^{2} ) \qquad ( 14 )$$

$${P}_{c} = \frac{\overline{μ}}{{k}_{min} {λ}_{c}} = {k}_{min} {λ}_{c} p . \qquad ( 15 )$$

Substituting Equation (1) into Equation (14) gives

$${P}_{c} = \frac{\overline{μ} {t}_{c} ( 2 {r}_{c} {k}_{min}^{2} {λ}_{c}^{5} - 2 {r}_{c} {λ}_{c} - {t}_{c} {k}_{min}^{2} {λ}_{c}^{4} + {t}_{c} )}{{k}_{min} {λ}_{c} ( {k}_{min} {r}_{c}^{2} {λ}_{c}^{4} - 2 {t}_{c} {r}_{c} {λ}_{c} + {t}_{c}^{2} )} . \qquad ( 16 )$$

Assuming pressure in the actuator is Pₐ and water flows through the CSBs and actuators is incompressible, the Darcy-Weisbach equation is given as

$$\frac{Δ P}{L} = {f}_{D} \frac{ρ}{2} \frac{{v}^{2}}{\overline{D}} , \qquad ( 17 )$$

where ΔP is the pressure difference between the CSBs and the actuator, L is the pipe length, ρ is the water density, v is mean flow velocity, and D is the pipe inner diameter. For the purpose of simplicity, although there are different pipe fittings and pipes with different diameters, they are considered as one single pipe with an effective length L̅ƒ_{D} is the Darcy friction factor when it is laminar,

$${f}_{D} = \frac{64}{Re} ,$$

where Re is the Reynolds number. When it is turbulence, by applying the Swamee-Jain equation

$${f}_{D} = \frac{0.25}{{[ log ( \frac{s / D}{3.7} + \frac{5.74}{{Re}^{0.9}} ) ]}^{2}} , \qquad ( 18 )$$

where ϵ is the absolute roughness. Substituting Equation (18) into Equation (17) gives

$$Δ P = \{ \begin{matrix}\frac{64 ρ \overline{L} {v}^{2}}{2 ReD} , & laminar , \\ \frac{0.25}{{[ log ( \frac{s / D}{3.7} + \frac{5.74}{{Re}^{0.69}} ) ]}^{2}} \frac{ρ \overline{L} {v}^{2}}{2 D} , & turbulence .\end{matrix} \qquad ( 19 )$$

### CSB Validation Experiments

The working performance of CSBs is based on at least one of two features: (1) The CSBs have large enough deformation to store enough water for the actuators. (2) The pressure difference between the CSBs and the actuators is large enough to generate large flow and increase response time. In this case, the CSBs' pressure versus strain relationship was tested first. Then, the relationship between flow rate and pressure difference was tested with the proposed CSB-based hydraulic system. At last, the whole hydraulic system's performance was evaluated compared with no CSB condition.

### Experimental Setup

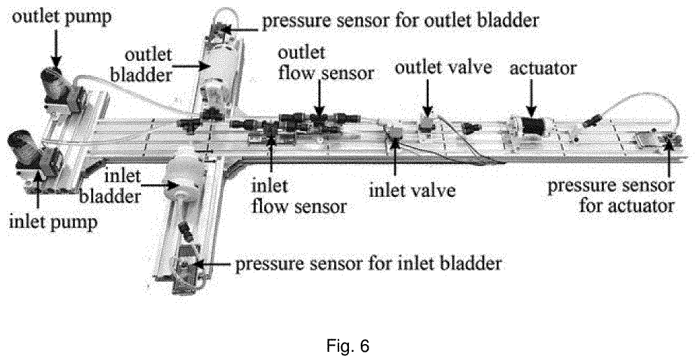

The experimental setup is shown in FIG. 6. The hydraulic path in the experiment was the same as the hydraulic system mentioned in the Conceptual Design and System Overview section, except there was only one actuator in the experimental setup. Three pressure sensors (TSCDRRN015PDUCV; Honeywell International Inc.) were used to record pressure for the CSBs and the actuator, respectively. Two flow sensors (FS2012-1001-LQ; Integrated Device Technology, Inc.) were placed in both the inlet path and the outlet path right after the valves for CSBs' flow rate measurements. The actuator and CSBs used in the experiments were the same as the ones in the hydraulic system and the underwater manipulator. Both the actuator and the two CSBs were fixed to the platform at one end while the other end could freely move. The pipe length that connected the CSBs and actuator to the pressure sensors was set so that when the CSBs or the actuators were deforming, the resistance of bending the pipe was negligible.

### Pressure and Strain Validation

The pressure versus strain relationship was first tested in this subsection. Principle stretch ratios (λe and λc) were measured with every 1 psi pressure increased. This procedure was repeated five times, and the mean value was used for each point. FIG. 5d shows the testing results. The two blue curves are analytical models from Equations (11) and (16), and the effective initial shear modulus μ̅ was 65 psi for the inlet CSB and 40 psi for the outlet CSB. Both the models fitted well with experimental data; the root mean square error (RMSE) was 0.012 for inlet CSB and 0.005 for outlet CSB, illustrating that both the analytical models fitted well with experimental data. One can specifically design the CSB with respect to the amount of water needed to be stored by using the pre-established model.

### Flow Rate and Pressure Difference Relationship Validation

The relationships between pressure difference and flow rate for the two CSBs were tested separately, as the two CSBs had different analytical models. The inlet CSB testing steps were as follows: (1) The pressure for the inlet CSB was set to 13 psi and water began to be pumped into the CSB. The inlet valve remained closed and pressure in the actuator was 0. (2) When the CSB reached the preset pressure, the inlet pump was closed. Then, the inlet valve was opened and water began to flow from the CSB to the actuator due to pressure difference. The flow rate and pressure of the CSB and actuator were measured during this process. (3) When the pressure difference between the CSB and the actuator reached 0, the inlet valve was closed. (4) The above procedures were repeated five times. The outlet CSB followed similar steps except for the outlet CSB was preset to negative pressure and the actuator was filled with water (pressure=6 psi), so that the pressure difference was also 13 psi at the beginning, and there was enough water inside the actuator for the outlet CSB to suck out. The testing results are shown in FIG. 5e; the effective length was 0.5 and 1 m for the inlet CSB and outlet CSB, respectively. Both the analytical and experimental results indicated that for both of the CSBs, with the increase of pressure difference, flow velocity would increase rapidly. However, when the flow became turbulence, the rise of flow velocity significantly reduced when the pressure difference was increased.

### Tracking Performance Evaluation

Four different system setups were tested to evaluate the system's tracking performance:

S-a: One wrist actuator, one inlet pump, no CSB.

S-b: One wrist actuator, one inlet CSB, one inlet pump.

S-c: One wrist actuator controlled by a hydraulic system with both inlet and outlet CSBs and their corresponding pumps.

S-d: S-c with a shorter gripper actuator.

Three different pressure signals were given to the four setups:

P-a: Was a step function with a 6-s time interval.

P-b: Was a 0.25 Hz sinusoidal signal.

P-c: Was a sinusoidal waveform with increased frequency.

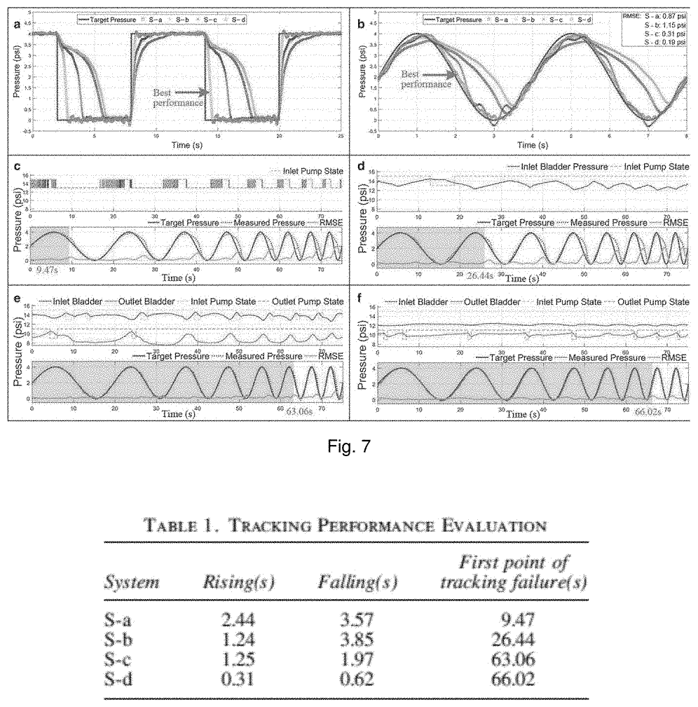

The results are shown in FIG. 7 and Table 1.

For P-a tracking (FIG. 7a and Table 1), S-b and S-c halved the rising time compared with S-a, and S-c also halved the falling time compared with S-a and S-b. Apart from that, S-d had a significantly reduced rising and falling time (up to 687%) compared with the rest three systems, illustrating that with the same CSB setup, the smaller the actuator, the faster the charging/discharging rate. In the P-b tracking test (FIG. 7b), S-c and S-d had much smaller RMSE compared with S-a and S-b, and S-d had the smallest RMSE (0.19 psi). For the sake of comparison and easy understanding, when evaluating the tracking performance of P-c (FIG. 7c-7f), we assumed that when the RMSE was below 10% (0.4 psi), the system was able to follow the given signal. Also, the time when RMSE first exceeded, the threshold (critical time) was recorded as a reference. Both S-b and S-c had a larger critical time compared with S-a (Table 1). S-d had similar performance compared with S-c; one possibility could be that although S-d needed less water for the same pressure change, the valve's mechanical properties could not provide enough switching frequency. In summary, it is demonstrated that the CSB-based hydraulic system can significantly increase system response time compared with no CSB systems.

### Underwater Manipulation System Experiments

According to the design concepts, besides fast response time, the underwater manipulation system also satisfies at least one of: (1) compactness and (2) wide working depth range. In this case, the manipulator was fit into a consumer-grade ROV and tested under different depths. Also, a specially designed task was carried out to test the manipulator's dexterity and accuracy.

### Soft Actuator Experiments

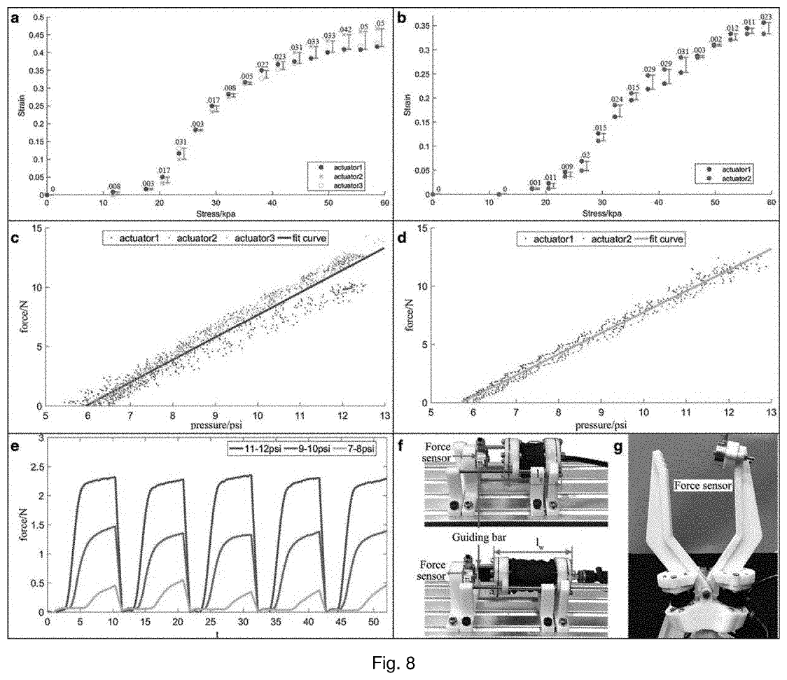

As illustrated in the Experimental Setup section, the five actuators used in the manipulator followed the same design for the purpose of modularization and simplicity. To justify the feasibility of this design, the actuators' stress versus strain, and pressure versus force relationships were tested. The testing setup is shown in FIG. 8f. All the parts were fixed except one end of the actuator could move along the guiding bar. The friction between the guiding bar and the actuator was negligible (<0.1 N).

The results for stress versus strain tests are shown in FIG. 8a and FIG. 8b. Both of the two kinds of actuators had little elongation at the very beginning. The deformation became more significant when the pressure reached between 30 and 40 kpa for both wrist actuators and gripper actuators. As the pressure kept increasing, the elongation became slow again. Actuators in the same group showed little difference in the stress versus strain relationship. For wrist actuators, the mean error was 0.022, and for gripper actuators, the mean error was 0.0138. Pressure versus force validation results are shown in FIGS. 8c and d, both fitting curves fitted well with measured data. For the wrist actuators, the RMSE was 0.58, 0.48, and 0.26 N, respectively, and the overall RMSE was 0.81 N. For the gripper actuators, the RMSE was 0.49 and 0.39 N, respectively, and the overall RMSE was 0.44 N.

### Hybrid Underwater Gripper Experiments

A bench test was first carried out to evaluate the gripper's gripping force. A force sensor was mounted at the tip of the gripper (FIG. 8g) and the inlet CSB was set to three different pressure ranges to see the CSBs influence on the gripping force. As shown in FIG. 8e, the CSBs working pressure and gripping force had a positive relationship, illustrating that the gripping force can be modified by adjusting the CSBs working pressure ranges.

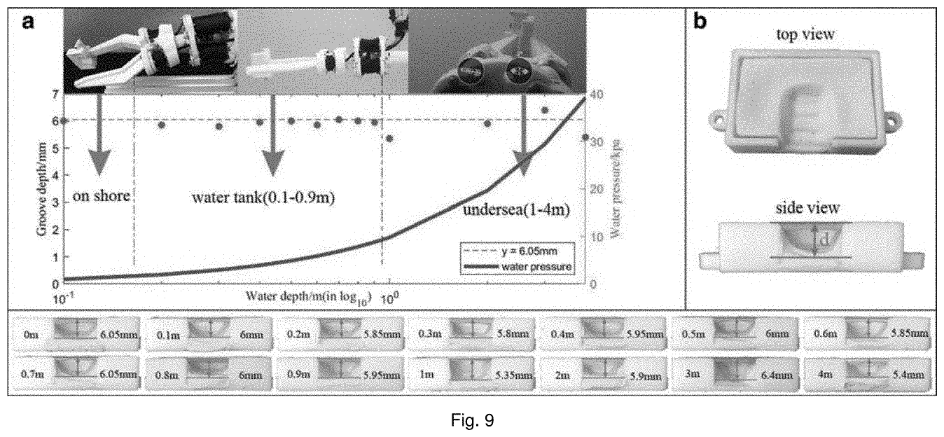

The manipulation system was also tested under different water depths to demonstrate that the CSB-based hydraulic system was decoupled with water depth. A 3D printed box filled with clay was used for force measurement (FIG. 9b) based on at least one of three reasons: (1) Ability to retain its shape after testing and after leaving the water, and for long-term records (in contrast, spring scale will return to normal length once gripping was released). (2) Directly comparable results between different locations and depths, easily visualizable in postanalysis. (3) Being a passive device, no additional power or wiring was required, simple to implement in multisite tests. The box was mounted at the tip of the gripper (FIG. 9a), and the depth of the groove was measured on behalf of the gripping force (FIG. 9b). To limit variables, all boxes were weighted between 10.1 and 10.2 g, the gripping time was set to 15 s, and CSBs working pressure was set to 13-14 psi. This test was carried out in three different places: onshore, in a water tank, and undersea; the onshore test was used as a reference and three boxes were used for each depth.

The results are shown in FIG. 9a. The groove depth measured onshore was 6.05 mm (blue dashed line), and the rest points were evenly distributed along the line, with an RMSE of 0.3 mm. The conclusion can be drawn that the CSB-based hydraulic system was independent of ambient water depth.

### Hybrid Underwater Manipulation System Experiments

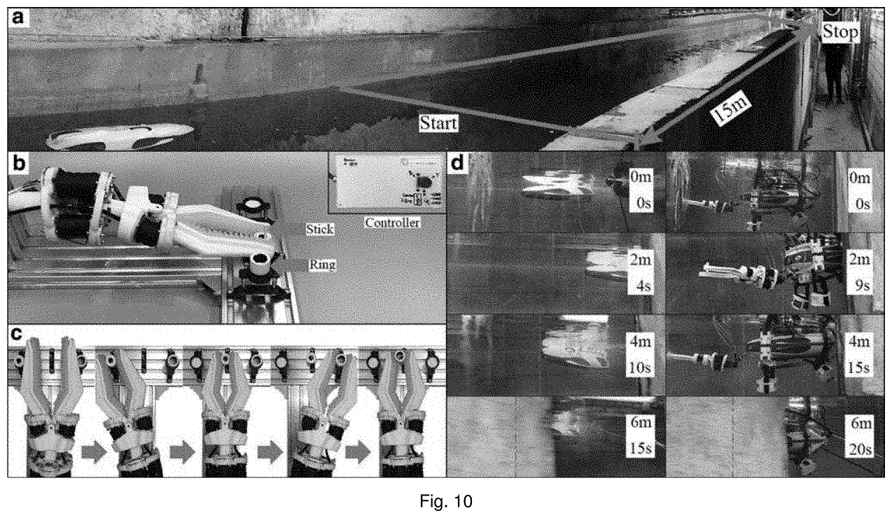

The experimental setup is shown in FIG. 10b. Two 3D printed rings were placed at two sides and a thin long stick was in the middle. One needed to control the manipulator using the controller and picked up two rings and placed them through the stick in the middle (FIG. 10c). To quantify overall system performance, assuming the inner diameter of the ring was D, and the diameter of the stick was 3 mm, if the manipulator could complete the task, the accuracy would be D−3 mm. This task was carried out both onshore and underwater. In both cases, the manipulator was able to complete the task with an accuracy of 1 mm. To evaluate the manipulation system's influence on underwater platforms, the whole system was mounted on a consumer-grade ROV for a speed test. The ROV was weighted about 3.8 kg, and the size was 465×270×126 mm. The ROV was required to travel a 15 m water tunnel as shown in FIG. 10a. One round with the manipulation system (FIG. 10d, right) and the other without (FIG. 10d, left). Due to the tensile force on the cable, and the difficulty of direction control in the narrow tunnel when velocity was too high, the ROVs power rating was set to medium. Both setups were tested three times. The results showed that when the manipulation system was on board, the average velocity (0.28 m/s) was 37.8% slower than that when there was only the ROV (0.45 m/s). One main reason for velocity loss was because the manipulation system largely increased the cross-sectional area and destroyed the streamline shape of the ROV. Given the speed of ocean current (0.08-0.25 m/s), the results demonstrated that mounting the manipulator would lead to a reduced speed of the ROV but still within a viable range.

An underwater hybrid manipulator with a lightweight CSB-based hydraulic actuation control system is described herein. The hybrid manipulator was designed such that the soft actuator design was decoupled with manipulator motion generation. Two CSBs were added into the hydraulic system for the purpose of equalizing ambient water pressure, reducing system bulkiness, and improving dynamic response. An analytical model was elaborated to explore the CSBs performance with respect to deformation, pressure, and flow rate, with well-fitting experimental results. Also, the tracking performance of the proposed hydraulic system was tested, and compared with no CSB condition, the CSBs can significantly improve system performance. Stress versus strain, and pressure versus force relationships for the soft actuator were also tested, and different individuals showed limited differences, justifying the feasibility of this modularized design. Then, the hybrid manipulation system was tested both onshore and underwater (see Appendix) with respect to gripping force and accuracy. The results showed that water depth did not have significant effects on the manipulator's performance, and the proposed underwater manipulation system could handle underwater tasks with good accuracy even without precise control feedback. Finally, a speed test was carried out to evaluate the system's compactness, and it turned out that even a consumer-grade ROV could travel with reasonable speed (0.28 m/s) with the underwater manipulation system described herein.

The devices, systems, and methods herein permit, with a hybrid manipulator and CSB-based hydraulic system, depth is no longer a factor that determines underwater manipulation performance, and even small underwater platforms (<4 kg) can manage complex underwater sampling tasks as good as heavy and expensive setups. The design concepts of the combined manipulator and hydraulic system serve as a benchmark for reducing system bulkiness and expenses, as large and costly underwater platforms are no longer an essential unit in shallow water sampling. Also, the enabling of small commercially available underwater platforms largely broadens the demographics of this field.

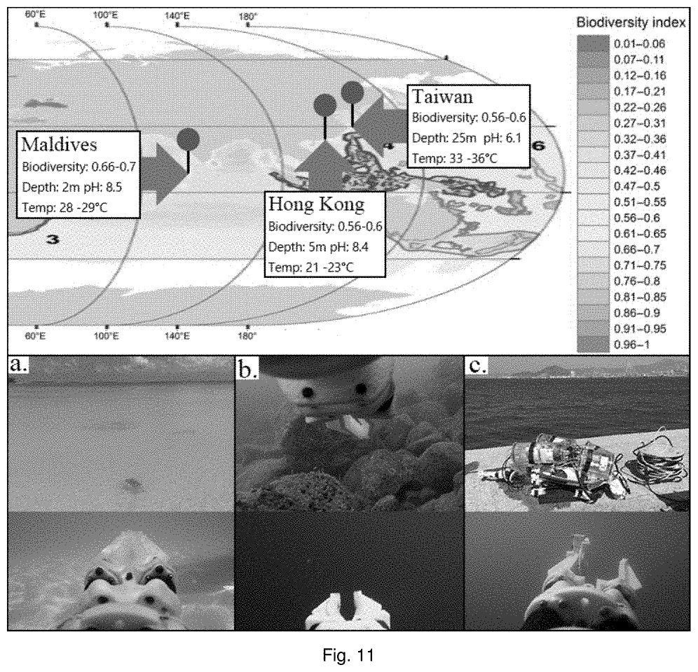

The developed prototype of the proposed soft-robotic manipulator system has been field-tested in three tropical and subtropical locations (FIG. 11). These places are hot spots of marine biodiversity, and the hydrographic and climatic conditions are as follows:

1) Hong Kong, tropical water (pH 8.4) with low temperature (21-23 degrees Celsius) low salinity (27-28 PSU for open sea water, salinity not applicable for indoor tank fresh water): four testing locations: a) in-door water tank with shallow depth and still water; b) in-door water tunnel; c) south-beach; d) western pier dockland.

2) Taiwan, Guishan Island, subtropical water (25 m), active undersea volcano harsh environment (pH=6.1 strong acid (sulfur)), highest temperature (33-36 degrees Celsius).

3) Maldives, Kandima Island coral lagoon, shallow (2 m) equatorial water (pH 8.5) with medium temperature (28-29 degrees Celsius) and high salinity (34 PSU).

Unless otherwise indicated in the examples and elsewhere in the specification and claims, all parts and percentages are by weight, all temperatures are in degrees Centigrade, and pressure is at or near atmospheric pressure.

With respect to any figure or numerical range for a given characteristic, a figure or a parameter from one range may be combined with another figure or a parameter from a different range for the same characteristic to generate a numerical range.

Other than in the operating examples, or where otherwise indicated, all numbers, values and/or expressions referring to quantities of ingredients, reaction conditions, etc., used in the specification and claims are to be understood as modified in all instances by the term “about.”

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A device for underwater applications, comprising:
a hybrid underwater manipulator; and
a hydraulic control framework comprising at least two compensating soft bladders.

2. The device for underwater applications according to claim 1, wherein the hybrid underwater manipulator comprises a joint and a gripper.

3. The device for underwater applications according to claim 1, wherein the hydraulic control framework comprises an inlet compensating soft bladder and an outlet compensating soft bladder.

4. The device for underwater applications according to claim 1, wherein the device has zero weight in water.

5. The device for underwater applications according to claim 1, further comprising a sensor in each actuator.

6. The device for underwater applications according to claim 1, wherein the hybrid underwater manipulator comprises a robot arm.

7. The device for underwater applications according to claim 1, wherein the device has a weight on dry land of 2.5 kg or less.

8. The device for underwater applications according to claim 1, wherein the device has a weight in water of about zero.

9. The device for underwater applications according to claim 1, wherein the device has two or more control loops.

10. An underwater remotely operated vehicle, comprising:
a hybrid underwater manipulator; and
a hydraulic control framework comprising at least two compensating soft bladders.

11. The underwater remotely operated vehicle according to claim 10, wherein the hybrid underwater manipulator comprises a joint and a gripper.

12. The underwater remotely operated vehicle according to claim 10, wherein the hydraulic control framework comprises an inlet compensating soft bladder and an outlet compensating soft bladder.

13. The underwater remotely operated vehicle according to claim 10, wherein the device has zero weight in water.

14. The underwater remotely operated vehicle according to claim 10, further comprising a sensor in each actuator.

15. The underwater remotely operated vehicle according to claim 10, wherein the hybrid underwater manipulator comprises a robot arm.

16. The underwater remotely operated vehicle according to claim 10, wherein the device has a weight on dry land of 2.5 kg or less.

17. The underwater remotely operated vehicle according to claim 10, wherein the device has a weight in water of about zero.

18. The underwater remotely operated vehicle according to claim 10, wherein the device has two or more control loops.
